(19) United States
(12) Patent Application Publication
(10) Pub. No.: US 2024/0246197 A1
(43) Pub. Date: Jul. 25, 2024

(54) SURFACE ROUGHNESS BLAST SPECIMEN FOR PROFILOMETER VERIFICATION

(71) Applicant: The Guyson Corporation of U.S.A., Saratoga Springs, NY (US)

(72) Inventors: Stephen Byrnes, Saratoga Springs, NY (US); Michael Bredderman, Saratoga Springs, NY (US); Isaiah Stanley, Saratoga Springs, NY (US)

(21) Appl. No.: 18/192,012

(22) Filed: Mar. 29, 2023

Related U.S. Application Data
(60) Provisional application No. 63/481,411, filed on Jan. 25, 2023.

(51) Int. Cl. B24C 1/04; B24C 11/00

(52) U.S. Cl. CPC B24C 1/04; B24C 11/00; G01B 5/28

(57) ABSTRACT

A blast specimen and method for creating a blast specimen. The blast specimen includes a metal substrate; and a blast surface, wherein the blast surface includes nonperiodic randomly sized peaks and valleys, and wherein the blast surface has a measurable roughness across a length of the blast surface that is within +/−5% of a target Ra value.

### TECHNICAL FIELD

The subject matter of this invention relates to nonperiodic surface roughness specimens for verifying profilometers and a method for producing nonperiodic surface roughness specimens.

### BACKGROUND

Highly specialized manufacturing operations often require metal surfaces to have a defined roughness achieved with a blasting operation. In some cases, the amount of roughness may be dictated by a type of coating being applied thereafter to the surface. In other cases, the amount of roughness may be specified to achieve a particular finish on a consumer product. Roughness is typically specified using an industry standard Ra (roughness average) value, as provided by ASME B46.1.

Unfortunately, controlling the amount of roughness with a high degree of accuracy in a blasting operation in which a media is shot at a surface can be extremely difficult. In order to ensure that the finished surface is meeting its desired roughness, profilometers are used to measure Ra values and the like. Profilometers operate by moving a stylus over a finished surface and recording and processing surface characteristics.

### SUMMARY

One aspect of the disclosure provides a blast specimen that comprises a metal substrate and a blast surface, wherein the blast surface includes nonperiodic randomly sized peaks and valleys, and wherein the blast surface has a measurable roughness across a length of the blast surface that is within +/−5% of a target Ra value.

A further aspect of the disclosure provides a method for creating a blast specimen, comprising: placing a mask over a metal substrate to create a workpiece, wherein the mask exposes a blast surface of the metal substrate; placing the workpiece in a robotic blasting chamber that includes a robot having a nozzle configured to deliver a blasting media; adjusting a pressure of the blasting media and a standoff of the nozzle to achieve a target Ra value; articulating the nozzle parallel to the workpiece while delivering the blasting media at the workpiece in a single pass to create a nonperiodic blast surface; and removing the workpiece from the robotic blasting chamber and removing the mask from the metal substrate to reveal the blast specimen.

A further aspect of the disclosure provides a method for creating a blast specimen, comprising: providing a metal substrate; placing the metal substrate in a robotic blasting chamber that includes a robot having a nozzle configured to deliver a blasting media; adjusting parameters of the robotic blasting chamber to settings that correspond to a target Ra value; articulating the nozzle parallel to the workpiece while delivering the blasting media at the metal substrate in a single pass to create a nonperiodic blasted surface; and removing the metal substrate from the robotic blasting chamber.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a finished blast specimen have a predefined nonperiodic roughness according to embodiments.

FIG. 2 depicts a profilometer measuring a surface according to embodiments.

FIG. 3 depicts data collected by a profilometer according to embodiments.

FIG. 4 shows a finished specimen having multiple measurable sectors according to embodiments.

FIG. 5 shows a mask fitted on a blank substrate in preparation for blasting according to embodiments.

FIG. 6 shows a blasting chamber for creating a finished specimen from a blank specimen according to embodiments.

FIG. 7 shows a set of blast specimens according to embodiments.

FIG. 8 shows a method of verifying a profilometer according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As noted, a blasting operation involves shooting a blasting media at a surface, which results in a nonperiodic roughened surface made up of a random collection of peaks and valleys. One of the issues with utilizing profilometers to obtain roughness measurements of blasted products is the fact that the profilometers can become uncalibrated and/or the profilometers are not properly calibrated for nonperiodic blasted surfaces. Accordingly, it is not uncommon for two different profilometers to generate two different roughness measurements for the same nonperiodic blasted surface. Aspects of this disclosure address this problem by providing nonperiodic roughness specimens (i.e., blast specimens) that act as masters for verifying profilometers, a method for manufacturing blast specimens, and a method for verifying profilometers using the manufactured blast specimens.

Currently, existing roughness coupons for calibrating or certifying (i.e., verifying) profilometers have periodic surfaces. Accordingly, profilometers calibrated with such coupons are only capable of ensuring the roughness accuracy of finished products having periodic surfaces. A periodic surface is one that has a repeated pattern created by a machine cutting tool moving across the surface. However, blast finishing is a nonperiodic process that creates a random surface pattern and the resulting Ra value of the finished piece cannot always be accurately determined using a profilometer calibrated with a periodic specimen. Blast specimens, as disclosed herein, will help ensure the accuracy of the profilometer and allow the user to achieve and measure a desired Ra value on a product finish created with a blasting operation.

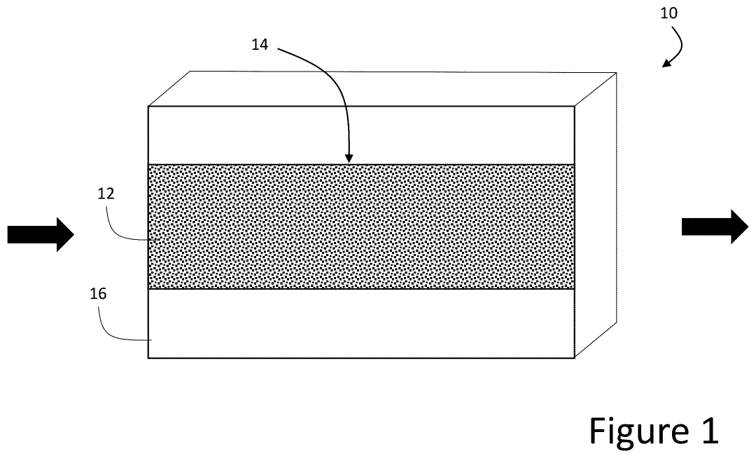

FIG. 1 depicts an illustrative nonperiodic blast specimen 10 that generally includes a metal substrate 16, a blast surface 12, and one or more directional guides 14. Specimen 10 is configured to be easily measured by industry standard profilometers, in which a profilometer stylus is dragged across the length of the blast surface 12 in the direction of the darkened arrows (or the opposite direction). In an illustrative embodiment, the length of the blast surface 12 is between one and two inches, and the width is between one half inch to an inch.

While the specific dimensions of the blast surface 12 can vary, in one embodiment, the length must be long enough to meet the minimal sampling length required by the ISO standard controlled testing process (ASTM D7127). Such a testing process can for example be implemented using the Mitutoyo® SJ or SV series profilometers, which requires a one inch surface length, and provides a detector range (Z direction) of 800 μm, a resolution of 0.000125 μm (at 8 μm range) and a measuring force of 4 mN.

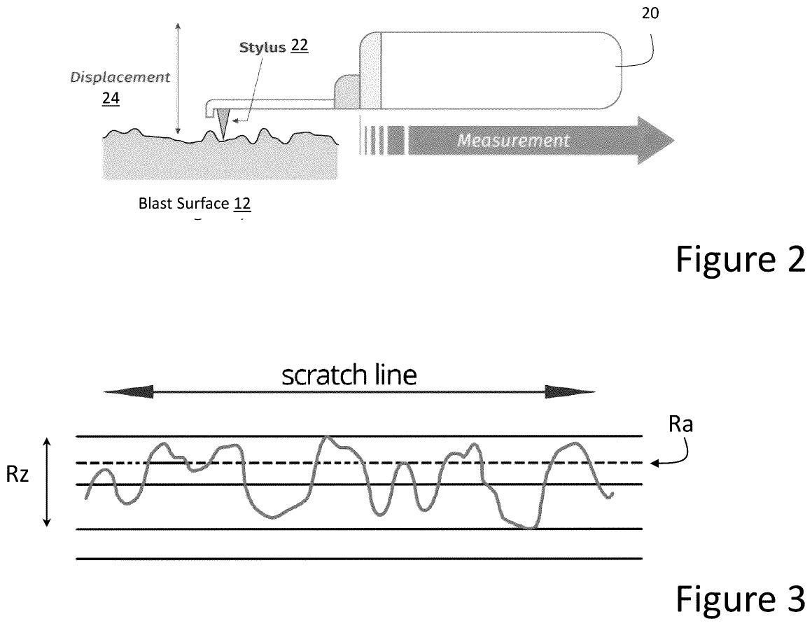

FIG. 2 depicts an example of a profilometer 20 having a stylus 22 being dragged across the blast surface 12 to record Z direction displacements, e.g., as shown in FIG. 3. Information, including the difference in heights between the peaks and valleys is analyzed by the profilometer 20 to provide various roughness measurements, most notably an Ra value. Ra is the arithmetic average of the absolute values of the profile height deviations from the mean line, recorded within the evaluation length. Simply put, Ra is the average of a set of individual measurements of surfaces peaks and valleys. Rz, which is another roughness measurement, is the difference between the tallest peak and the deepest valley in the surface. Other roughness measurements may also be collected.

To provide a nonperiodic blast specimen 10 that can be used to repeatedly verify the accuracy of a profilometer 20, the blast surface 12 of the specimen 10 must be created with a highly exacting roughness profile across the entire length. In an illustrative embodiment, the entire blast surface 12 of the present disclosure has a predetermined Ra that is guaranteed accurate within a 2-5% margin of error. For example, a 250 Ra blast specimen with a 3% margin of error is guaranteed to have a certifiable Ra of between 242.5 and 257.5, and a 5% margin of error is guaranteed to have a certifiable Ra of between 237.5 and 262.5.

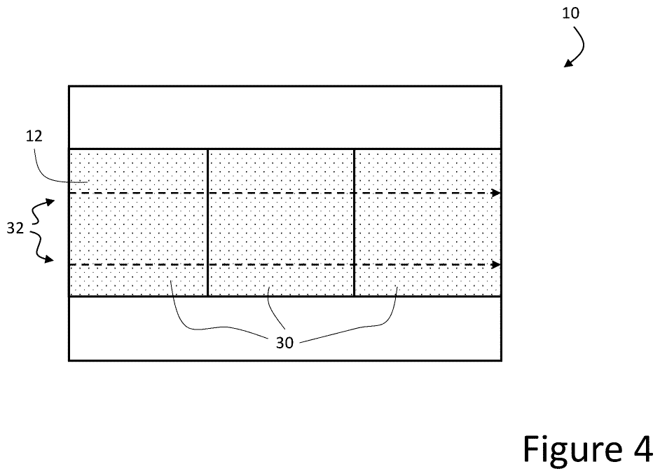

FIG. 4 depicts an example of how an Ra of a blast specimen 10 with a nonperiodic blast surface 12 can be determined in accordance with ISO standard ASTM D7127. In this example, two scratched lines 32 are shown, which are each created after a profilometer stylus is dragged there across (note that only one measurement/scratch is typically required). As shown, the blast surface 12 includes a plurality of sectors 30 (in this case, three sectors) that essentially form three different measurement regions. To ensure the accuracy of the Ra value of the specimen 10, an Ra value is collected from each sector 30 during a profilometer operation, and the resulting values are averaged to generate a final Ra value. Accordingly, the Ra of the blast specimen 10 is guaranteed accurate within a 5% margin of error based on an average Ra value of the plurality of sectors. While creating such a blast surface 12 would seem trivial, it has, in fact, never been achieved for a blast specimen 10 due at least in part to the fact that the surface peaks and valleys of a nonperiodic blast surface 12 are highly random when deploying a blasting operation.

In addition to providing a non-periodic blast surface with a target Ra value, the blast surface may also be provided with a target Rz value, which is the difference between the tallest “peak” and the deepest “valley” in the surface.

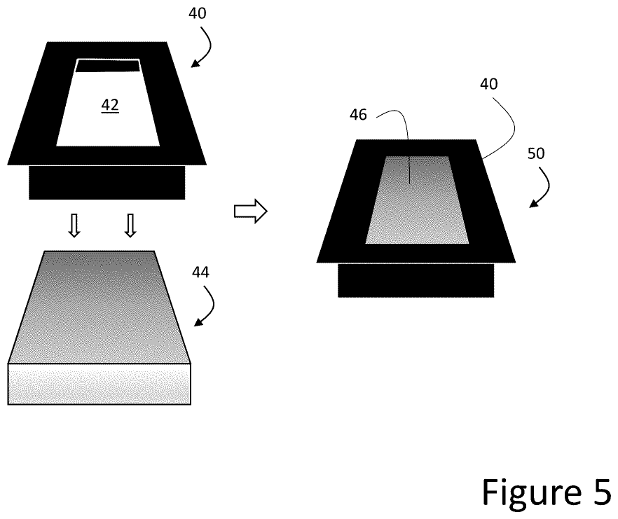

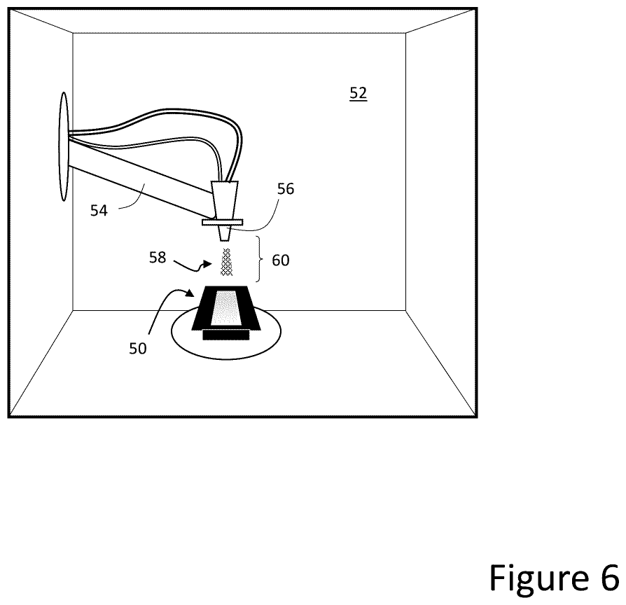

FIGS. 5 and 6 depict an illustrative process for creating a blast specimen 10. In this example, as shown in FIG. 5, a mask 40 having an opening 42 is placed over a metal substrate 44 such that a portion 46 of the substrate 44 is exposed, which will form the blast surface. The resulting workpiece 50 is then placed into a robotic blasting chamber 52 as shown in FIG. 6. Inside chamber 52 is a robot 54 having a nozzle 56 configured for delivering blasting media 58 at the workpiece 50. To achieve a blast specimen with the exacting requirements noted herein, the robot delivers the blast media 28 in a single pass (e.g., from back to front), at a predefined standoff 60, media type, blast pressure, angle of attack, and flow rate. In one aspect, the robot articulates the nozzle parallel to the workpiece to deliver the blasting media at the exposed surface of the workpiece in a single pass, maintaining a consistent standoff and angle.

In an illustrative example, the metal substrate comprises 304 stainless steel having approximately a 92 Rockwell B hardness, however, a hardness of between 80-100 on the Rockwell B hardness scale could be utilized. The Rockwell B hardness scale is an industry standard scale that measures indentation hardness of a material. The media type comprise may comprise a white aluminum oxide screened and controlled media. The media may be sieved to a controlled tolerance with a powered media classifier.

The stand-off 60 between the nozzle 56 and the work piece 50 is dependent on the desired Ra (e.g., about 7-12″ for 250 Ra) and the nozzle angle is 90 degrees to the workpiece 50. The nozzle traverse speed by the robot 54 is determined by the desired Ra (e.g., 5-20 mm/second for 250 Ra). The blast pressure at the regulator (not shown) is regulated based on the desired Ra (e.g., for a 250 Ra, the blast pressure at the regulator is 30-70 PSI and the blast pressure at the nozzle is 35-50 PSI, and the media flow rate is 2.0-5.0 lbs/minute). In this example, the blast nozzle 56 and associated pressure hose may include ones sold by Guyson®. In one illustrative embodiment, target Ra values are achieved by selecting parameters according to a table or the like as follows:

| Ra | Stand-off | Traverse Speed | Nozzle Blast Pressure | Flow Rate |
|---|---|---|---|---|
| 150 | 5-10 | 10-25 mm/sec | 25-40 PSI | 3.0 lbs/min |
| 250 | 7-12 | 5-20 mm/sec | 35-50 PSI | 4.0 lbs/min |
| 350 | 9-14 | 5-15 mm/sec | 45-60 PSI | 5.0 lbs/min |

It is understood that the above values are for illustrative purposes only and actual values in practice may change. In some cases, the robot is calibrated to produce different specimens with the selectable parameters shown in the table, thus making the process easily repeatable.

In an experiment, the above parameters were utilized to create a 250 Ra blast specimen. When analyzed with a Miutoyo Surftest SJ-410 profilometer using ISO1997 settings with an R profile, Gauss filter, λc=0.3 in, λs=1000 μin, and N=3, the final inspection measurements were recorded as Ra=243.69-254.45.

Different blast specimens with different Ra values can thus be readily achieved with a similar single pass blast operation by changing parameters. In a further embodiment, Ra values may be altered simply by changing the media grit size and blasting pressure. For example, a lower blast pressure and smaller media grit size will result in a lower Ra.

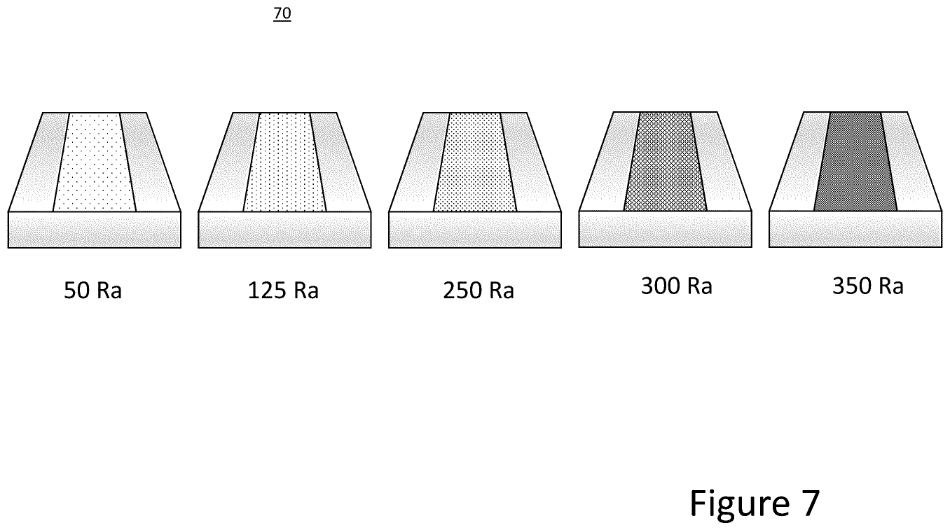

FIG. 7 depicts a set of blast specimens 70 manufactured as outlined herein. In this example, five specimens are included in the set ranging from 50 Ra to 350 Ra. It is understood however that the number and roughness of the blast specimens in a set 70 may vary.

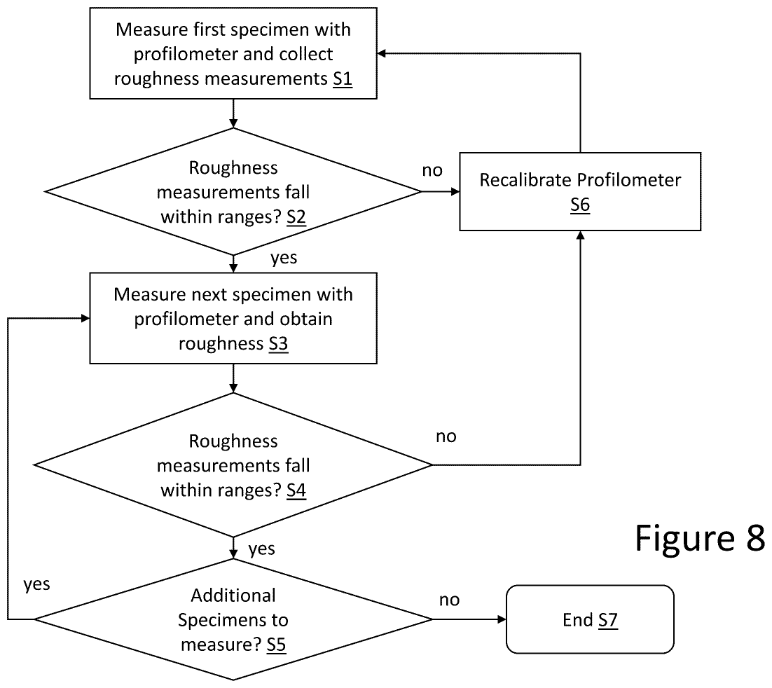

FIG. 8 depicts an illustrative method for verifying a profilometer using a set of blast specimens. At S1, a first blast specimen is measured with the profilometer, and roughness measurements are collected. At S2, a determination is made whether the measurements fall within expected ranges of the profilometer. For example, if a 100 Ra specimen is placed in the profilometer, the Ra readings should, e.g., be 95-105. If the measurements fall outside the expected ranges at S2, then the profilometer can be recalibrated at S6 and the test can be run again. If roughness measurements fall within the expected ranges at S2, then a next blast specimen from the set can be measured at S3. At S4, a determination can be made whether the roughness measurements fall within the expected ranges. If no at S4, the profilometer can be recalibrated at S6 and the test can be run again. If the roughness falls within the expected ranges at S4, a next specimen can be measured if one exists as determined at S5. Once all the specimens in the set have been measured and fall within the expected ranges, the process ends and the profilometer is verified.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A blast specimen, comprising:
a metal substrate; and
a blast surface, wherein the blast surface includes nonperiodic randomly sized peaks and valleys, and wherein the blast surface has a measurable roughness across a length of the blast surface that is within +/−5% of a target Ra value.

2. The blast specimen of claim 1, wherein the blast surface includes a directional guide.

3. The blast specimen of claim 1, wherein a length of the blast surface is between one and two inches, and a width of the blast surface is between one half inch to an inch.

4. The blast specimen of claim 1, wherein the blast surface includes a plurality of sectors that form different measurement regions.

5. The blast specimen of claim 1, wherein the metal substrate is comprised of stainless steel.

6. The blast specimen of claim 5, wherein the metal substrate has a hardness of approximately 92 on a Rockwell B hardness scale.

7. A method for creating a blast specimen, comprising:
placing a mask over a metal substrate to create a workpiece, wherein the mask exposes a blast surface of the metal substrate;
placing the workpiece in a robotic blasting chamber that includes a robot having a nozzle configured to deliver a blasting media;
adjusting a pressure of the blasting media and a standoff of the nozzle to achieve a target Ra value;
articulating the nozzle parallel to the workpiece while delivering the blasting media at the workpiece in a single pass to create a nonperiodic blast surface; and
removing the workpiece from the robotic blasting chamber and removing the mask from the metal substrate to reveal the blast specimen.

8. The method of claim 7, wherein the blasting media comprises a white aluminum oxide screened and controlled media.

9. The method of claim 7, wherein the blast specimen includes a measurable roughness across a length of the blast surface that is within +/−5% of the target Ra value.

10. The method of claim 7, wherein the metal substrate is comprised of stainless steel.

11. The method of claim 10, wherein the metal substrate has a hardness of approximately 92 on a Rockwell B hardness scale.

12. The method of claim 7, wherein a length of the blast surface is between one and two inches, and a width of the blast surface is between one half inch to an inch.

13. The method of claim 7, wherein a nozzle angle is 90 degrees to the workpiece 50.

14. The method of claim 7, further comprising adjusting a nozzle traverse speed to achieve the target Ra value.

15. The method of claim 14, wherein for a target Ra value of 250, the nozzle traverse speed is 5-20 mm/second, the blast pressure at the nozzle is 35-50 PSI, and the stand-off is 7-12″.

16. The method of claim 14, wherein the target Ra value is further determined by a media flow rate, and the media flow rate of the target Ra value of 250 is 2.0-5.0 pounds/minute.

17. A method for creating a blast specimen, comprising:
providing a metal substrate;
placing the metal substrate in a robotic blasting chamber that includes a robot having a nozzle configured to deliver a blasting media;
adjusting parameters of the robotic blasting chamber to settings that correspond to a target Ra value;
articulating the nozzle parallel to the workpiece while delivering the blasting media at the metal substrate in a single pass to create a nonperiodic blasted surface; and
removing the metal substrate from the robotic blasting chamber.

18. The method of claim 17, wherein the parameters include a size of the blasting media and a blast pressure.

19. The method of claim 18, wherein the blasting media includes white aluminum oxide.

20. The method of claim 18, wherein the target Ra value is selected from a set of values between 50 and 500.
